(19) United States
(12) Patent Application Publication
(10) Pub. No.: US 2024/0004672 A1
(43) Pub. Date: Jan. 4, 2024

(54) MITIGATION OF VISUAL CONFUSION WHILE TRANSFERRING RICH TEXT DATA ACROSS APPLICATIONS WITH INVERSELY COLORED THEMES

(71) Applicant: CITRIX SYSTEMS, INC., Fort Lauderdale, FL (US)

(72) Inventors: Hengbo Wang, Nanjing (CN); Feng Tao, Nanjing (CN); Daowen Wei, Nanjing (CN); Jian Ding, Nanjing (CN)

(21) Appl. No.: 17/870,471

(22) Filed: Jul. 21, 2022

Related U.S. Application Data
(63) Continuation of application No. PCT/CN2022/102196, filed on Jun. 29, 2022.

(51) Int. Cl. G06F 9/445; G06F 9/451

(52) U.S. Cl. CPC G06F 9/44505; G06F 9/451

(57) ABSTRACT

In some implementations, there may be provided a computer-implemented method that includes detecting, using at least one processor, a first action being executed on a data in a source computing application; determining, using the at least one processor, a source color theme associated with at least one of the source computing application and the data; determining, using the at least one processor, a destination color theme associated with a destination computing application, the destination computing application being communicatively coupled to the source application; comparing, using the at least one processor, the source color theme and the destination color theme; and executing, using the at least one processor, a second action on the data in the destination computing application based on the comparison of the source color theme and the destination color theme. Related systems, methods, and articles of manufacture are also disclosed.

### CROSS REFERENCE TO RELATED APPLICATIONS

This application is a Bypass Continuation application of International Application No. PCT/CN2022/102196, filed Jul. 15, 2022 and entitled “MITIGATION OF VISUAL CONFUSION WHILE TRANSFERRING RICH TEXT DATA ACROSS APPLICATIONS WITH INVERSELY COLORED THEMES,” the disclosure of which is incorporated herein by reference in its entirety.

### BACKGROUND

Software applications execute various functions that may include generation of user interfaces displaying various data. User interfaces and data they display may include their own respective color themes, such as, for example, light color theme with dark color text, etc. Users of such software applications periodically transfer such data from one user interface to another. When transferring data from one user interface having one color theme to another user interface having another color theme, the data might not be visually observable by the user due to differences in color themes.

### SUMMARY

In some implementations, there may be provided a computer-implemented method that includes detecting, using at least one processor, a first action being executed on a data in a source computing application; determining, using the at least one processor, a source color theme associated with at least one of the source computing application and the data; determining, using the at least one processor, a destination color theme associated with a destination computing application, the destination computing application being communicatively coupled to the source application; comparing, using the at least one processor, the source color theme and the destination color theme; and executing, using the at least one processor, a second action on the data in the destination computing application based on the comparison of the source color theme and the destination color theme.

In some implementations, the current subject matter may include one or more of the following optional features. At least one of the source computing application and the destination computing application include at least one of the following: a software application, a user interface window of a software application, and any combination thereof. The source computing application and the destination computing application are different computing applications. The source computing application and the destination computing application are same computing applications. The data includes at least one of the following: a video, an audio, an image, a graphics data, a text data, a rich text data, and any combination thereof. The first action includes a copy action, and the second action includes a paste action. The destination color theme is different from the source color theme. The comparing includes changing a first color of the data associated with the source application into a second color for the executing of the second action. The comparing includes adding highlighting to the data for the executing of the second action. The comparing includes retaining a color of the data associated with the source application for the executing of the second action.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a system for executing theme recognition and transformation, according to some implementations of the current subject matter;

FIG. 2 illustrates exemplary “light mode” interface and a “dark mode” interface;

FIG. 3 illustrates an example process for executing transformation of data between different color theme applications, according to some implementations of the current subject matter;

FIG. 4 illustrates further details of the transformation that may be executed by the transformation component shown in FIG. 1, according to some implementations of the current subject matter;

FIG. 5 illustrates an example image analysis process for determining a color theme of a window of an application, according to some implementations of the current subject matter;

FIG. 6 illustrates various transformation options, according to some implementations of the current subject matter;

FIG. 7 illustrates an example of a network environment, according to some implementations of the current subject matter;

FIG. 8 depicts a block diagram illustrating an example of a computing device, according to some implementations of the current subject matter;

FIG. 9 illustrates a high-level architecture of an example of a virtualization system for implementing the computing system shown in FIG. 1, according to some implementations of the current subject matter;

FIG. 10 illustrates an example of a method, according to some implementations of the current subject matter.

### DETAILED DESCRIPTION

To address the deficiencies of currently available solutions, one or more implementations of the current subject matter provide for an ability to mitigate visual confusion while transferring rich text data across applications with inversely colored themes.

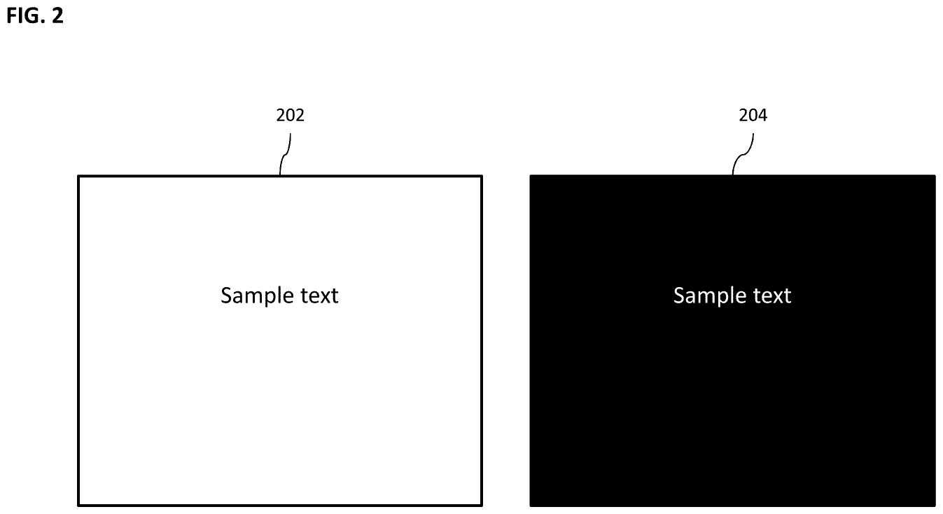

In some implementations, the current subject matter may be configured to provide an ability to reduce and/or eliminate visual confusion when certain graphical objects (e.g., images, text, rich text, graphics, etc.) are transferred between different color-themed user interface screens. For example, modern software applications (e.g., desktop applications, mobile applications, etc.) usually provide its users with multiple (e.g., dual) graphical user interface (GUI) themes, such as for example, a “light mode” (e.g., lighter or white colored background with darker color text fonts) and a “dark mode” (e.g., darker or black colored background with lighter color text fonts. FIG. 2 illustrates exemplary “light mode” interface 202 and a “dark mode” interface 204. As shown in FIG. 2, interface 202 includes text “sample text” in dark font, and interface 204 includes text “sample text” in light font. The interfaces 202 and 204 may belong to the same application and/or different applications.

In some cases, while transferring rich text data (e.g., along with color) across different user interface screens (e.g., belonging to the same or different applications) with inversely colored themes, the end user may be subject to visual confusion. For example, data being copied from application A may have inverse color with application A's theme so that it can be clearly presented in the user interface generated by application A, e.g., interface 202 shown in FIG. 2. This means that the data is very likely to be close with application B's user interface theme in color, e.g., interface 204 shown in FIG. 2, where the dark colored text in interface 202 will blend with the dark theme of interface 204 and will not be seen or readable.

In some implementations, the current subject matter may be configured to address and/or eliminate such visual confusion (e.g., at operating system service level, which will interact with an operating system clipboard component and independent of any high-level applications). The current subject matter may be configured to detect themes (e.g., dark, light) of both a source application and a destination application during execution of various actions (e.g., a copy-paste action, whereby a user is copying a dark-colored text from a light themed application to a dark themed application) and then determine whether a rich text data is being copied and/or whether color transformation of the text may need to be performed concurrently with the executed action.

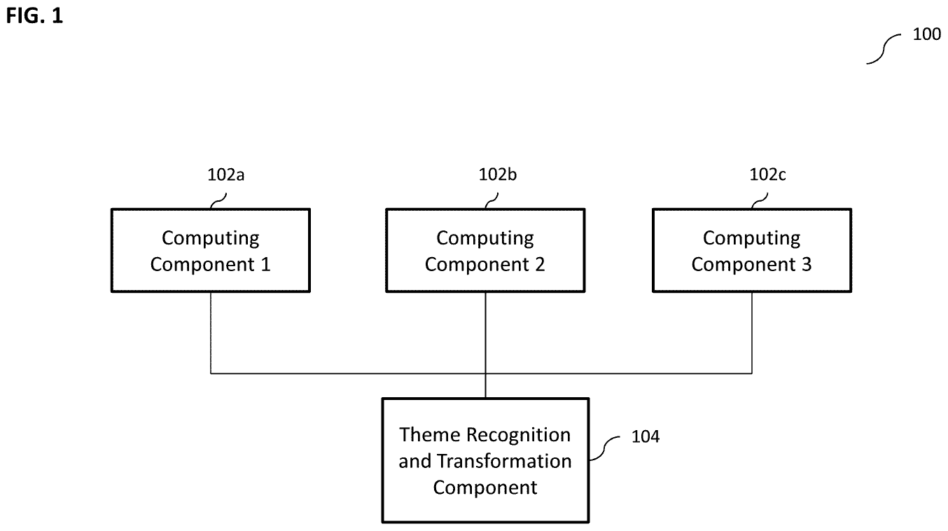

FIG. 1 illustrates an example of a system 100 for executing theme recognition and transformation, according to some implementations of the current subject matter. The system 100 may be configured to include one or more computing components 102 (a, b, c) and a theme recognition and transformation component 104. The components 102 may be configured to process, transmit and/or receive various information, data, files, etc., which may include at least one of the following: a video, an audio, an image, a graphics data, a text data, a rich text data, and/or any other information, data, file, etc. that may or may not include a video, an audio, an image, a graphics data, a text data, a rich text data, and/or any other data file (“data file”).

The system 100 may be configured to be implemented in one or more servers, one or more databases, a cloud storage location, a memory, a file system, a file sharing platform, a streaming system platform and/or device, and/or in any other platform, device, system, etc., and/or any combination thereof. One or more components of the system 100 may be communicatively coupled using one or more communications networks. The communications networks can include at least one of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

The components of the system 100 may include any combination of hardware and/or software. In some implementations, such components may be disposed on one or more computing devices, such as, server(s), database(s), personal computer(s), laptop(s), cellular telephone(s), smartphone(s), tablet computer(s), and/or any other computing devices and/or any combination thereof. In some implementations, these components may be disposed on a single computing device and/or can be part of a single communications network. Alternatively, or in addition to, the components may be separately located from one another.

Referring back to FIG. 1, the components 102 may be configured to include different types of software applications (e.g., word processing, video conferencing, email processing, etc.) that may be implemented on a single computer, whereby a user may perform various actions, such as, copying and pasting data (e.g., text, rich text, etc.) from one application to another (e.g., from computing component 102a (e.g., a word processing application) to component 102b (e.g., a messaging application)). Each component 102 may be configured to have different color themes implemented on them. For example, component 102a may have a light color theme and component 102b may have a dark color theme, whereby transferring dark colored text from component 102a to component 102b may result in the transferred text to become not visible to the user in view of component 102b's dark color theme.

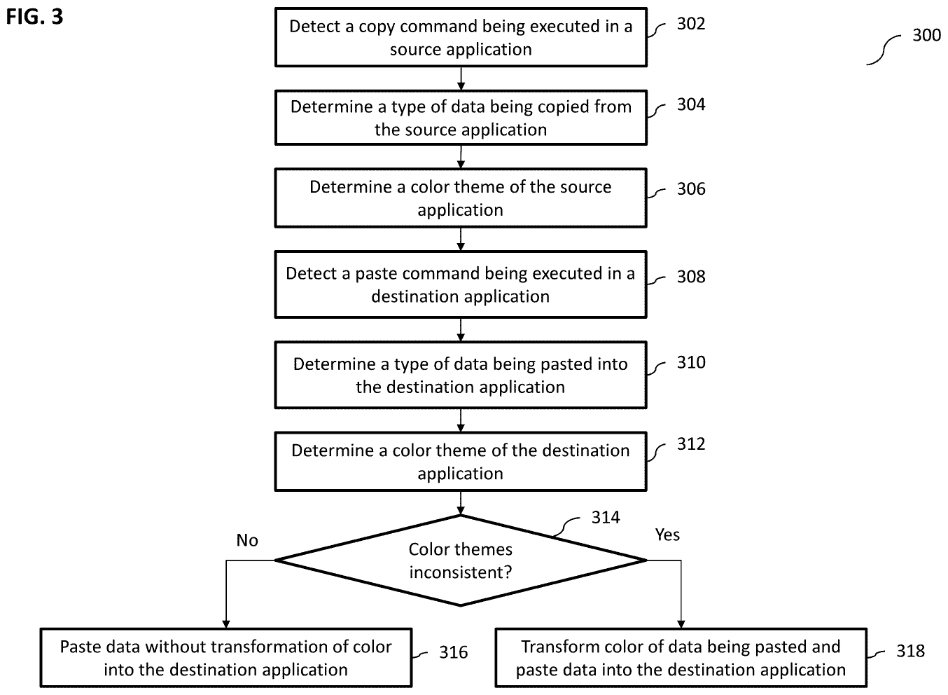

FIG. 3 illustrates an example process 300 for executing transformation of data between different color theme applications, according to some implementations of the current subject matter. The process 300 may be executed by the system 100 shown in FIG. 1. At 302, the component 104 may be configured to detect a copy command being executed in a source application, e.g., computing component 102a. For example, the computing component 102a may be a word processing application and the user determined to copy a particular text for the purposes of pasting it a destination application, e.g., component 102b, which may be an online messaging application.

At 304, the component 104 may determine a type of data being copied from the source application (i.e., component 102a). For example, the data that is being copied includes a rich text, a normal text, etc. The component 104 may also be configured to record various information about the source application (e.g., type of application, timestamp of copy, etc.).

At 306, the component 104 may be configured to detect source application's color theme. In particular, the component 104 may be configured to determine that application's window from which data is being copied from for pasting into a window of the destination application. By way of a non-limiting example, the theme may be dark, light, and/or any other color.

At 308, the component 104 may be configured to detect a paste command being executed in the destination application, e.g., component 102b. The component 104 may also determine a type of data that is being pasted into the destination application, at 310. For example, the data that is being pasted may include a rich text, a normal text, etc. The component 104 may also be configured to record various information about the destination application (e.g., type of application, timestamp of paste command, etc.).

At 312, the component 104 may be configured to detect destination application's color theme. In particular, the component 104 may be configured to determine the destination application's window into which data is being pasted to from a window of the source application. Again, by way of a non-limiting example, the theme may be dark, light, and/or any other color.

At 314, the component may be configured to compare theme modes of the source and destination applications. If the modes are inconsistent or different, the component 104 may be configured to apply a color transformation to the data being copied/pasted (e.g., dark text from light-theme application 102a being pasted into dark-theme application 102b), so that it can be clearly shown in destination application, at 318. The dark color of the data may be transformed into a light color and then pasted. Otherwise, at 316, if the color themes are not inconsistent or different, then the component 104 may be configured to perform pasting without any color transformation.

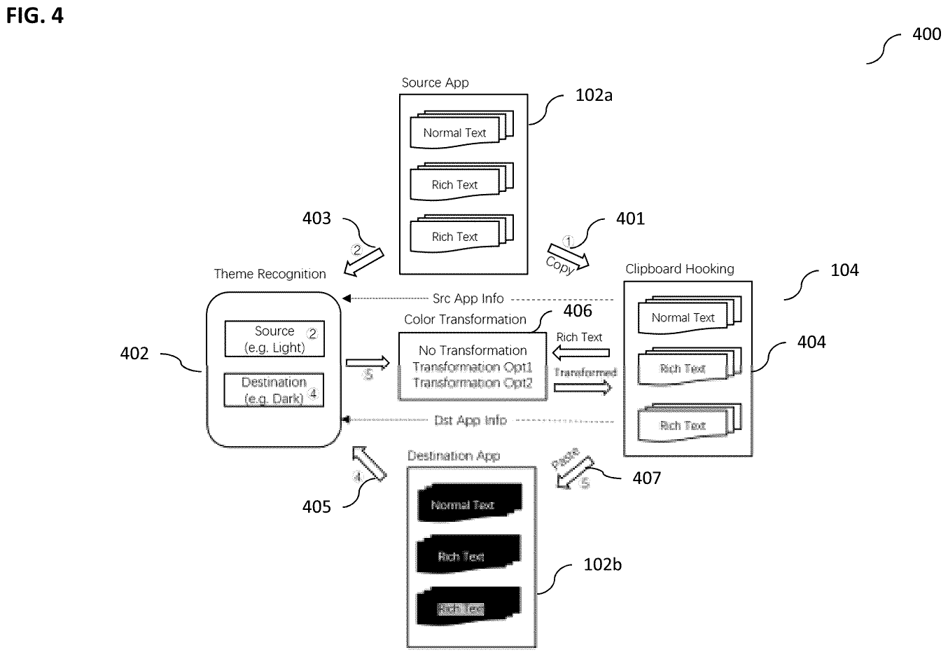

FIG. 4 illustrates further details of the transformation that may be executed by the component 104, according to some implementations of the current subject matter. The component 104 may be configured to include a theme recognition component 402, a clipboard hooking component 404, and a color transformation component 406. As shown in FIG. 4, components 402-406 may be configured to interact with one another as well as with source application or component 102a (“Source App”) and destination application or component 102b (“Destination App”). The source application 102a may be configured to include various text, e.g., “Normal Text”, “Rich Text”, that may be displayed in one or more user interface windows of the application 102a. A copy 401 may be detected by the component 104, and in particular by the clipboard hooking component 404. The clipboard hooking component 404 may be configured to be integrated with an operation system's clipboard component that may be part of the computing system that is configured to execute the application 102a. The clipboard hooking component 404 may detect any a “copy” and “paste” command executed in the operation system and may record one or more properties of the application 102a where this command had originated. Table 1 illustrates examples of such recorded properties.

TABLE 1
Application properties being recorded
by the clipboard hooking component 104.

| Property | Explanation |
|---|---|
| Application Name | Application name where either “copy” or “paste” |
| | action takes place |
| Application PID | Unique identifier of the application instance |
| Application Window | The window where the data is copied or pasted |
| Handle | |
| Rich Text | Yes or NO |

The clipboard hooking component may be configured to provide the source application information (“Src App Info”) to the theme recognition component 402. The theme recognition component 402 may then use the provided source application information to detect, at 403, a color theme of the window of the source application from which the data is being copied. For example, the color theme may be a dark mode, a light mode, etc.

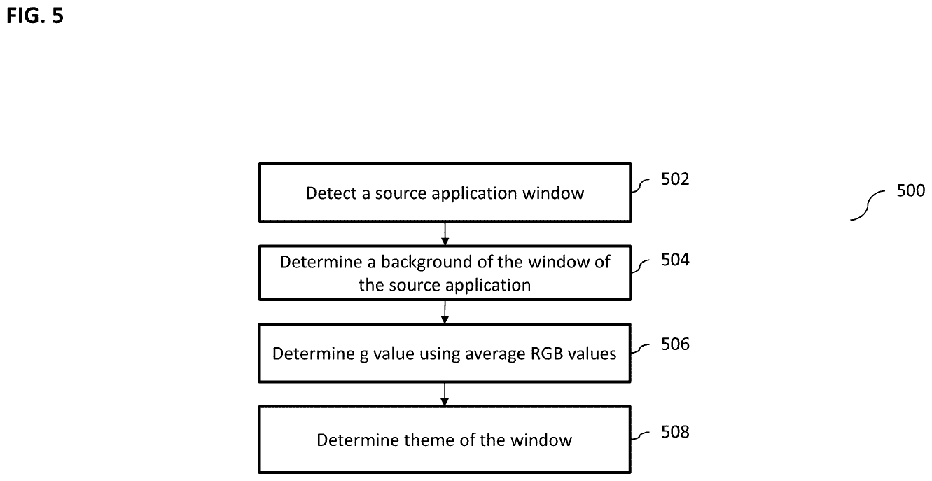

FIG. 5 illustrates an example image analysis process 500 for determining a color theme of a window of an application, according to some implementations of the current subject matter. At 502, the component 402 may be configured to detect the source application window, e.g., the window from which data is being copied from. The component 402 may be configured to obtain an image clip of the application window.

At 504, the component 402 may be configured to determine a background of the detected window. As part of this determination, the component 402 may be configured to execute a background subtraction process (e.g., using a ViBe model to segment or subtract a background scene from an image) to obtain only a background scene. Although ViBe is referred to in the prior example as a way subtract out a background scene in an image or video sequence, other types of models may be used to separate a foreground object(s) in motion from a still or a relative slowly varying background.

At 506, the component 402 may be configured to read red-green-blue (RGB) values of each pixel in the determined background scene and determine one or more averaged RGB values. To determine theme of the window, at 508, the component 402 may be configured to use the determined RGB values to determine one or more color theme values g using the following:

g=R*0.2999+G*0.587+B*0.114 (1)

where each of the above coefficients for each of the values R, G, B may be experimentally determined.

If g is less than a predetermined threshold (e.g., having an empirical value of 100), the application window may be determined to be in a dark themed mode. Otherwise, the window may be determined to be in a light themed mode. The determination of color themes of the windows may be performed in a similar fashion for the source and destination applications.

Referring back to FIG. 4, the theme recognition component 402 may be configured to provide information about the color theme of the windows (e.g., of source and/or destination applications) to the color transformation component 406. The color transformation component 406 may be configured to determine whether it is necessary to apply a color transformation of the data that is being copied from application/component 102a and pasted into application/component 102b. This determination may be made based on the color themes provided by the source application, at 403, and destination application, at 405. For example, the source application 102a may indicate that its color theme is light and the destination application 102b may indicate that its color theme is dark. This information may be also provided to the theme recognition component 402 (and subsequently, passed on to the color transformation component 406) in addition to the source and destination application information that may be provided by the clipboard hooking component 404.

The component 406 may determine whether transformation of color of the data may be needed. For example, it may be determined that a rich text is being copied from component 102a and pasted to component 102b having different color themes, and as such, transformation of the color of the text may be needed.

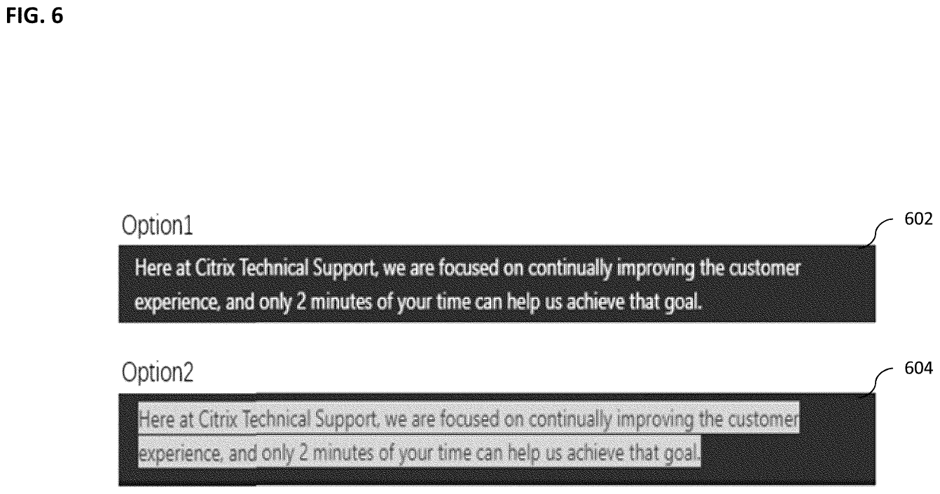

Further, the component 406 may be configured to execute one or more of the following options: no color transformation, a first transformation option, and/or a second transformation option. Using the first transformation option (e.g., option 602 shown in FIG. 6), the component 406 may be configured to change, for example, a font color of the rich text data to be inverse with the theme of destination application (i.e., component 102b), as shown in FIG. 4, where in the destination application 102b, the words “Rich Text” are changed from dark color (shown in the source application 102a) to light color (shown in the destination application 102b). Using the second option (e.g., option 604 shown in FIG. 6), the component 406 may be configured to attach, for example, a background highlight to the rich text data being pasted, which may be configured to differentiate from the dark theme of destination application (i.e., component 102b), as shown in FIG. 4, where in the destination application 102b, the words “Rich Text” are highlighted. Table 2 summarizes various changes that may be executed by the color transformation component 406 during a copy and paste command executed between different applications and/or application windows.

TABLE 2
Color transformation

| | Source | | Destina- | | Color |
|---|---|---|---|---|---|
| Source | App | Destina- | tion App | Rich | Transformation |
| App | Theme | tion App | Theme | Text? | Required? |
| Component | Light | Component | Light | N | N |
| 102a | | 102b | | | |
| Component | Light | Component | Light | Y | N |
| 102a | | 102b | | | |
| Component | Light | Component | Dark | N | N |
| 102a | | 102b | | | |
| Component | Light | Component | Dark | Y | Y |
| 102a | | 102b | | | |
| Component | Dark | Component | Light | N | N |
| 102a | | 102b | | | |
| Component | Dark | Component | Light | Y | Y |
| 102a | | 102b | | | |

Upon execution of one or more of the transformation options (as discussed above), the transformed data may be provided to the clipboard hooking component 404, which may in turn cause pasting, at 407, of the data into the destination application/component 102b in accordance with one of the options.

One of the advantages of the current subject matter is that its detection and transformation processes are independent of the types of data that may be transferred between different applications and/or windows within the same application. Moreover, the current subject matter processes are also independent of the types of applications. As such, it may be capable of resolving visual confusion irrespective of the color themes of each application (e.g., source, destination).

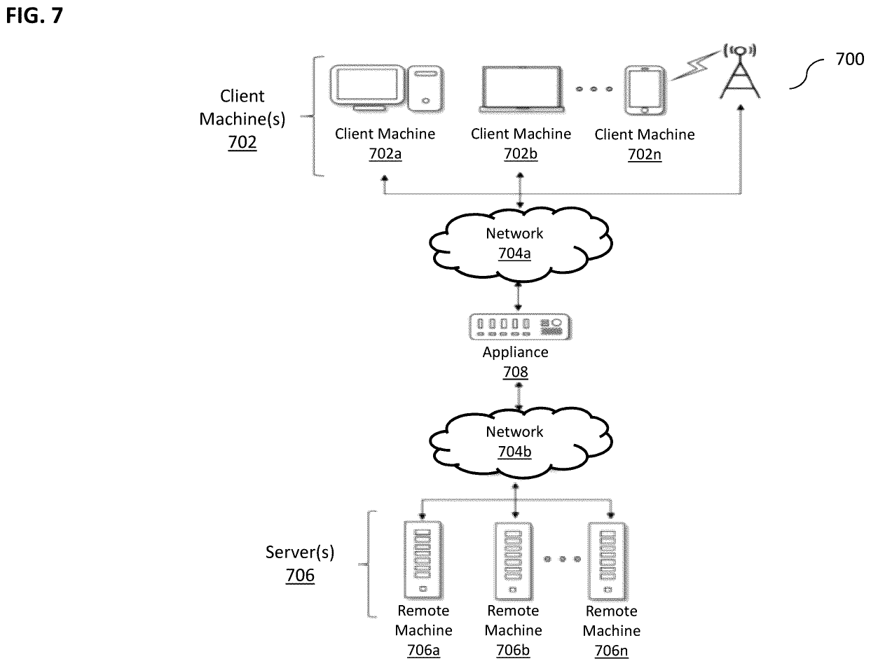

FIG. 7 illustrates an example of a network environment 700, according to some implementations of the current subject matter. Referring to FIGS. 1-6, the network environment 700, in which various aspects of the disclosure may be implemented, may include one or more clients 702a-704n, one or more remote machines 706a-706n, one or more networks 704a and 704b, and one or more appliances 708 installed within the network environment 700. The clients 702a-702n communicate with the remote machines 706a-706n via the networks 704a and 704b.

In some example implementations, the clients 702a-702n may communicate with the remote machines 706a-706n via an appliance 708. The illustrated appliance 708 is positioned between the networks 704a and 704b, and may also be referred to as a network interface or gateway. In some example implementations, the appliance 708 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example implementations, multiple appliances 708 may be used, and the appliance(s) 708 may be deployed as part of the network 704a and/or 704b.

The clients 702a-702n may be generally referred to as client machines, local machines, clients, client nodes, client computers, client devices, computing devices, endpoints, or endpoint nodes. One or more of the clients 702a-702n may implement, for example, the client device 102 and/or the like. The remote machines 706a-706n may be generally referred to as servers or a server farm. In some example implementations, a client 702 may have the capacity to function as both a client node seeking access to resources provided by a server 706 and as a server 706 providing access to hosted resources for other clients 702a-702n. The networks 704a and 704b may be generally referred to as a network 704. The network 704 including the networks 704a and 704b may be configured in any combination of wired and wireless networks.

The servers 706 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 706 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example implementations, a server 706 may execute a remote presentation services program or other program that uses a thin-client or a remote-display protocol to capture display output generated by an application executing on a server 706 and transmit the application display output to a client 702.

In yet other example implementations, a server 706 may execute a virtual machine, such as the first virtual machine and/or the second virtual machine, to provide, for example, to the user at a client device, access to a computing environment such as the virtual desktop. The virtual machine may be managed by, for example, a hypervisor (e.g., a first hypervisor, a second hypervisor, and/or the like), a virtual machine manager (VMM), or any other hardware virtualization technique within the server 706.

In some example implementations, the network 704 may be a local-area network (LAN), a metropolitan area network (MAN), a wide area network (WAN), a primary public network, and/or a primary private network. Additional implementations may include one or more mobile telephone networks that use various protocols to communicate among mobile devices. For short-range communications within a wireless local-area network (WLAN), the protocols may include 1002.11, Bluetooth, and Near Field Communication (NFC).

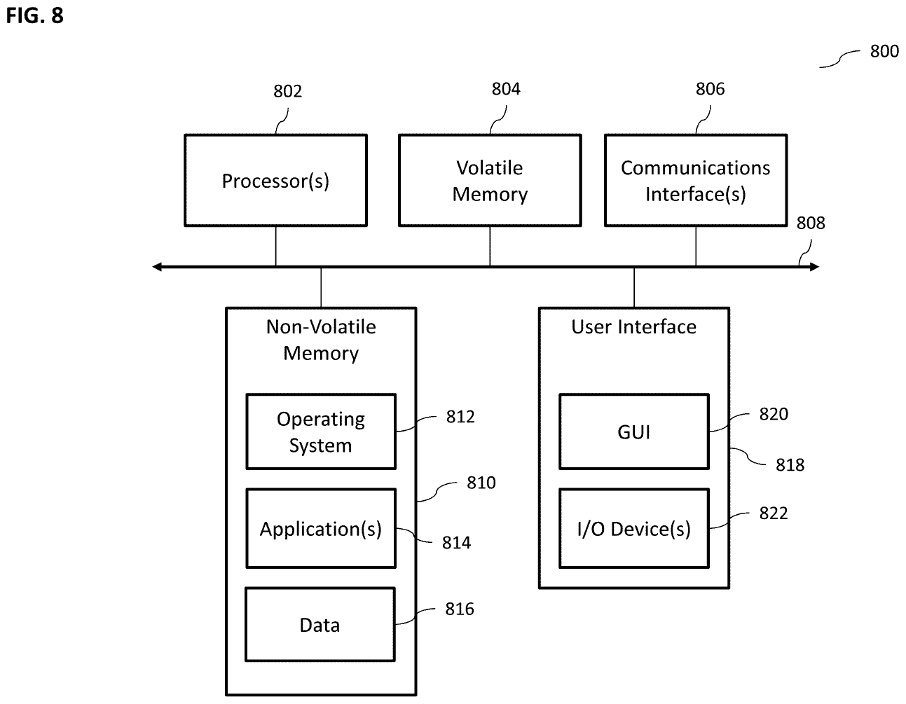

FIG. 8 depicts a block diagram illustrating an example of a computing device 800, in accordance with some example implementations. Referring to FIGS. 1-7, the computing device 800 may be useful for practicing an implementation of the system 100.

As shown in FIG. 8, the computing device 800 may include one or more processors 802, volatile memory 804 (e.g., RAM), non-volatile memory 810 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 818, one or more communications interfaces 806, and a communication bus 808. The user interface 818 may include a graphical user interface (GUI) 820 (e.g., a touchscreen, a display, and/or the like) and one or more input/output (I/O) devices 822 (e.g., a mouse, a keyboard, and/or the like). The non-volatile memory 810 may store an operating system 812, one or more applications 814, and data 816 such that computer instructions of the operating system 812 and/or applications 814 are executed by the processor(s) 802 out of the volatile memory 804. Data may be entered using an input device of the GUI 820 or received from I/O device(s) 822. Various elements of the computing device 800 may communicate via communication the communication bus 808. The computing device 800 as shown in FIG. 8 is shown merely as an example, and may be implemented by any computing or processing environment and with any type of machine or set of machines that may have suitable hardware and/or software capable of operating as described herein.

The processor(s) 802 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example implementations, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example implementations, the “processor” may be one or more physical processors or one or more “virtual” (e.g., remotely located or “cloud”) processors.

The communications interfaces 806 may include one or more interfaces to enable the computing device 800 to access a computer network such as a local area network (LAN), a wide area network (WAN), a public land mobile network (PLMN), and/or the Internet through a variety of wired and/or wireless or cellular connections.

As noted above, in some example implementations, one or more computing devices 800 may execute an application on behalf of a user of a client computing device (e.g., clients 702), may execute a virtual machine, which provides an execution session within which applications execute on behalf of a user or a client computing device (e.g., clients 702), such as a hosted desktop session (e.g., a virtual desktop), may execute a terminal services session to provide a hosted desktop environment, or may provide access to a computing environment including one or more of: one or more applications, one or more desktop applications, and one or more desktop sessions in which one or more applications may execute.

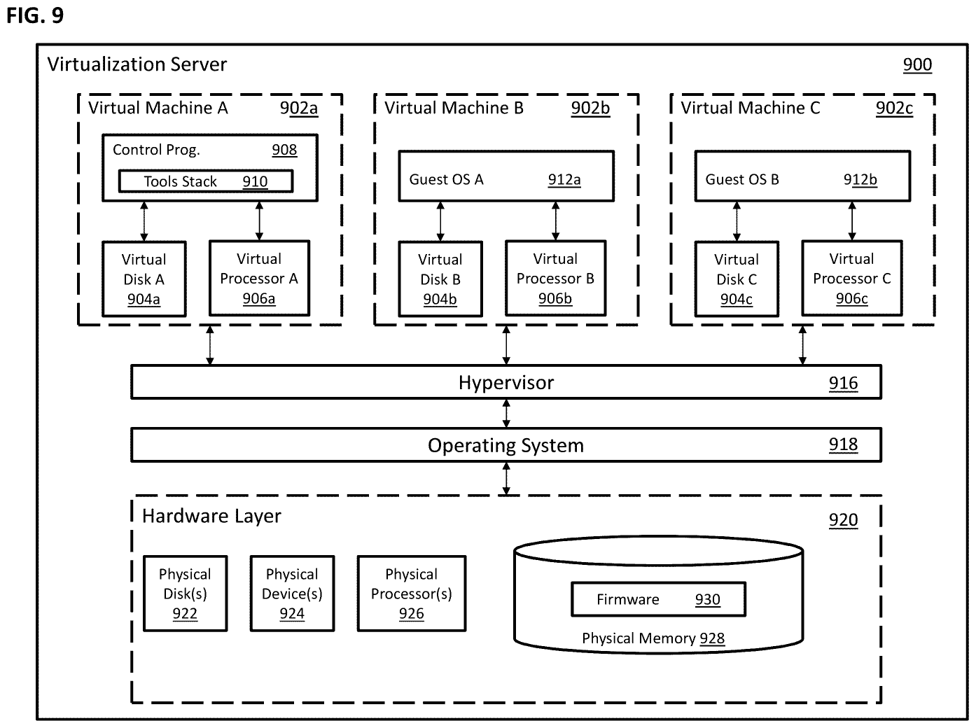

FIG. 9 illustrates a high-level architecture of an example of a virtualization system for implementing the computing system 100, in accordance with some example implementations. As shown in FIG. 9, the virtualization system may be a single-server or multi-server system, or a cloud system, including at least one virtualization server 900 configured to provide virtual desktops and/or virtual applications to one or more client access devices 702a-c. A desktop (or a virtual desktop) may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 900 may be configured as a virtualization server in a virtualization environment, for example, a single-server, multi-server, or cloud computing environment. Virtualization server 900 illustrated in FIG. 9 may be deployed as and/or implemented by one or more implementations of server 706 illustrated in FIG. 7 or by other known computing devices. Included in virtualization server 900 is hardware layer 920 that may include one or more physical disks 922, one or more physical devices 924, one or more physical processors 926, and one or more physical memories 928. In some implementations, firmware 930 may be stored within a memory element in physical memory 928 and be executed by one or more of physical processors 926. Virtualization server 900 may further include operating system 918 that may be stored in a memory element in physical memory 928 and executed by one or more of physical processors 926. Still further, hypervisor 916 may be stored in a memory element in physical memory 928 and be executed by one or more of physical processors 926. Presence of operating system 918 may be optional.

Executing on one or more of physical processors 926 may be one or more virtual machines 902A-C (generally, 902). Each virtual machine 902 may have virtual disk 904A-C and virtual processor 906A-C. In some implementations, first virtual machine 902A may execute, using virtual processor 906A, control program 908 that includes tools stack 910. Control program 908 may be referred to as a control virtual machine, Domain 0, Dom0, or other virtual machine used for system administration and/or control. In some implementations, one or more virtual machines 902B-C may execute, using virtual processor 906B-C, guest operating system 912A-B (generally, 912).

Physical devices 924 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 900. Physical memory 928 in hardware layer 920 may include any type of memory. Physical memory 928 may store data, and in some implementations may store one or more programs, or set of executable instructions. FIG. 9 illustrates an implementation where firmware 930 is stored within physical memory 928 of virtualization server 900. Programs or executable instructions stored in physical memory 928 may be executed by the one or more processors 926 of virtualization server 900.

Virtualization server 900 may also include hypervisor 916. In some implementations, hypervisor 916 may be a program executed by processors 926 on virtualization server 900 to create and manage any number of virtual machines 902. Hypervisor 916 may be referred to as a virtual machine monitor, or platform virtualization software. In some implementations, hypervisor 916 may be any combination of executable instructions and hardware that monitors virtual machines 902 executing on a computing machine. Hypervisor 916 may be a Type 2 hypervisor, where the hypervisor executes within operating system 918 executing on virtualization server 900. Virtual machines may then execute at a layer above hypervisor 916. In some implementations, the Type 2 hypervisor may execute within the context of a user's operating system such that the Type 2 hypervisor interacts with the user's operating system. In other implementations, one or more virtualization servers 900 in a virtualization environment may instead include a Type 1 hypervisor (not shown). A Type 1 hypervisor may execute on virtualization server 900 by directly accessing the hardware and resources within hardware layer 920. That is, while Type 2 hypervisor 916 accesses system resources through host operating system 918, as shown, a Type 1 hypervisor may directly access all system resources without host operating system 918. A Type 1 hypervisor may execute directly on one or more physical processors 926 of virtualization server 900, and may include program data stored in physical memory 928.

Hypervisor 916, in some implementations, may provide virtual resources to guest operating systems 912 or control programs 908 executing on virtual machines 902 in any manner that simulates operating systems 912 or control programs 908 having direct access to system resources. System resources can include, but are not limited to, physical devices 924, physical disks 922, physical processors 926, physical memory 928, and any other component included in hardware layer 920 of virtualization server 900. Hypervisor 916 may be used to emulate virtual hardware, partition physical hardware, virtualize physical hardware, and/or execute virtual machines that provide access to computing environments. In still other implementations, hypervisor 916 may control processor scheduling and memory partitioning for virtual machine 902 executing on virtualization server 900. Examples of hypervisor 916 may include those manufactured by VMWare, Inc., of Palo Alto, California; Xen Project® hypervisor, an open source product whose development is overseen by the open source XenProject.org community; Hyper-V®, Virtual Server®, and Virtual PC® hypervisors provided by Microsoft Corporation of Redmond, Washington; or others. The virtualization server 900 may execute hypervisor 916 that creates a virtual machine platform on which guest operating systems 912 may execute. When this is the case, virtualization server 900 may be referred to as a host server. An example of such a virtualization server is Citrix Hypervisor® provided by Citrix Systems, Inc., of Fort Lauderdale, Florida.

Hypervisor 916 may create one or more virtual machines 902B-C (generally, 902) in which guest operating systems 912 execute. In some implementations, hypervisor 916 may load a virtual machine image to create virtual machine 902. The virtual machine image may refer to a collection of data, states, instructions, etc. that make up an instance of a virtual machine. In other implementations, hypervisor 916 may execute guest operating system 912 within virtual machine 902. In still other implementations, virtual machine 902 may execute guest operating system 912.

In addition to creating virtual machines 902, hypervisor 916 may control the execution of at least one virtual machine 902. The hypervisor 916 may present at least one virtual machine 902 with an abstraction of at least one hardware resource provided by virtualization server 900 (e.g., any hardware resource available within hardware layer 920). In some implementations, hypervisor 916 may control the manner in which virtual machines 902 access physical processors 926 available in virtualization server 900. Controlling access to physical processors 926 may include determining whether virtual machine 902 should have access to processor 926, and how physical processor capabilities are presented to virtual machine 902.

As shown in FIG. 9, the virtualization server 900 may host or execute one or more virtual machines 902. Virtual machine 902 may be a set of executable instructions and/or user data that, when executed by processor 926, may imitate the operation of a physical computer such that virtual machine 902 can execute programs and processes much like a physical computing device. While FIG. 9 illustrates an implementation where virtualization server 900 hosts three virtual machines 902, in other implementations virtualization server 900 may host any number of virtual machines 902. Hypervisor 916 may provide each virtual machine 902 with a unique virtual view of the physical hardware, including memory 928, processor 926, and other system resources 922, 924 available to that virtual machine 902. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 916 may create one or more unsecure virtual machines 902 and one or more secure virtual machines 902. Unsecure virtual machines 902 may be prevented from accessing resources, hardware, memory locations, and programs that secure virtual machines 902 may be permitted to access. In other implementations, hypervisor 916 may provide each virtual machine 902 with a substantially similar virtual view of the physical hardware, memory, processor, and other system resources available to virtual machines 902.

Each virtual machine 902 may include virtual disk 904A-C (generally 904) and virtual processor 906A-C (generally 906.) Virtual disk 904 may be a virtualized view of one or more physical disks 922 of virtualization server 900, or a portion of one or more physical disks 922 of virtualization server 900. The virtualized view of physical disks 922 may be generated, provided, and managed by hypervisor 916. In some implementations, hypervisor 916 may provide each virtual machine 902 with a unique view of physical disks 922. These particular virtual disk 904 (included in each virtual machine 902) may be unique, when compared with other virtual disks 904.

Virtual processor 906 may be a virtualized view of one or more physical processors 926 of virtualization server 900. The virtualized view of physical processors 926 may be generated, provided, and managed by hypervisor 916. Virtual processor 906 may have substantially all of the same characteristics of at least one physical processor 926. Virtual processor 926 may provide a modified view of physical processors 926 such that at least some of the characteristics of virtual processor 906 are different from the characteristics of the corresponding physical processor 926.

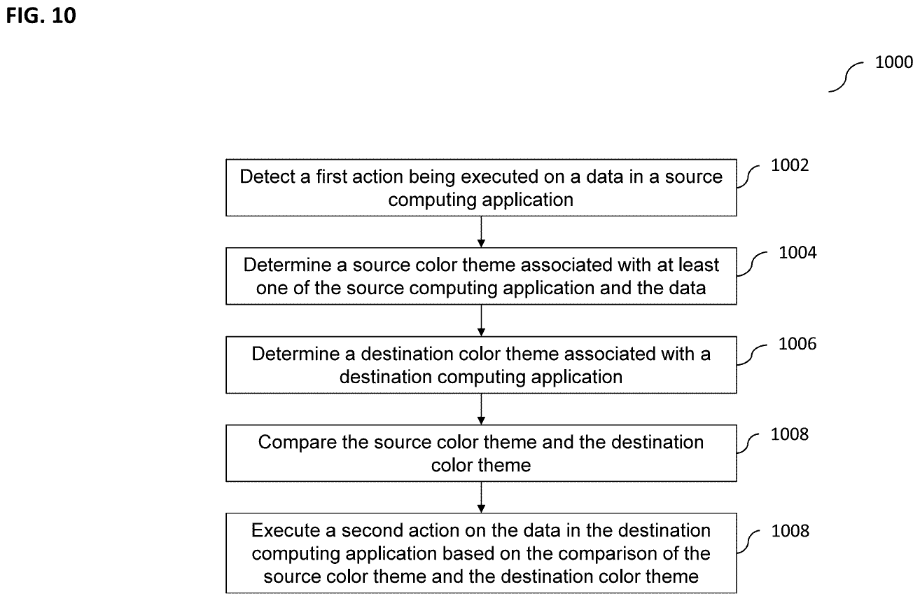

FIG. 10 illustrates an example of a method 1000 for executing transformation of data for use of the data in different computing applications, computing applications' windows, etc. to avoid visual confusion that may be associated with differing color themes of such computing applications, computing applications' windows, etc. The method 1000 may be performed using the system 100, such as, for example, the component 104 as shown and discussed in connection with FIGS. 1-6 above.

At 1002, the component 104 may be configured to detect a first action (e.g., a copy action) being executed on a data in a source computing application (e.g., component 102a). For example, the copy action may be executed on a rich text data present in a word processing application.

At 1004, the component 104 may determine a source color theme associated with at least one of the source computing application and the data. For example, the component 104 may determine that the color theme of the source application 102a is light and the text that is being copied is dark. This information may be provided to the clipboard component 404, shown in FIG. 4, which in turn may provide it to the theme recognition component 402.

At 1006, the component 104 may also determine a destination color theme associated with a destination computing application (e.g., destination application 102b). The destination computing application may be communicatively coupled to the source application, e.g., a user may wish to copy certain data from the source application 102a and paste it into the destination application 102b. The destination application's color theme may also be provided to the clipboard component 404, which in turn may provide it to the theme recognition component 402.

At 1008, the component 104 may compare the source color theme and the destination color theme. Upon comparison, the color transformation component 406 may be configured to execute one or more of the options discussed above (e.g., no transformation, option 1 (change color of the text), and/or option 2 (add highlighting to the text)).

At 1010, the component 104 may execute a second action (e.g., paste) on the data in the destination computing application based on the comparison of the source color theme and the destination color theme.

In some implementations, the current subject matter can include one or more of the following optional features. At least one of the source computing application and the destination computing application may include at least one of the following: a software application, a user interface window of a software application, and any combination thereof.

In some implementations, the source computing application and the destination computing application may be different computing applications. Alternatively, or in addition, the source computing application and the destination computing application may be same computing applications (e.g., actions may be performed on different windows of the application).

In some implementations, the data may include at least one of the following: a video, an audio, an image, a graphics data, a text data, a rich text data, and any combination thereof.

In some implementations, the first action may include a copy action, and the second action may include a paste action.

In some implementations, the destination color theme may be different from the source color theme.

In some implementations, the comparing may include changing a first color of the data associated with the source application into a second color for the executing of the second action. Alternatively, or in addition, the comparing may include adding highlighting to the data for the executing of the second action. Further, comparing may include retaining a color of the data associated with the source application for the executing of the second action.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
detecting, using at least one processor, a first action being executed on a data in a source computing application;
determining, using the at least one processor, a source color theme associated with at least one of the source computing application and the data;
determining, using the at least one processor, a destination color theme associated with a destination computing application, the destination computing application being communicatively coupled to the source application;
comparing, using the at least one processor, the source color theme and the destination color theme; and
executing, using the at least one processor, a second action on the data in the destination computing application based on the comparison of the source color theme and the destination color theme.

2. The method according to claim 1, wherein at least one of the source computing application and the destination computing application include at least one of the following: a software application, a user interface window of a software application, and any combination thereof.

3. The method according to claim 1, wherein the source computing application and the destination computing application are different computing applications.

4. The method according to claim 1, wherein the source computing application and the destination computing application are same computing applications.

5. The method according claim 1, wherein the data includes at least one of the following: a video, an audio, an image, a graphics data, a text data, a rich text data, and any combination thereof.

6. The method according to claim 1, wherein the first action includes a copy action, and the second action includes a paste action.

7. The method according to claim 1, wherein the destination color theme is different from the source color theme.

8. The method according to claim 1, wherein the comparing includes changing a first color of the data associated with the source application into a second color for the executing of the second action.

9. The method according to claim 1, wherein the comparing includes adding highlighting to the data for the executing of the second action.

10. The method according to claim 1, wherein the comparing includes retaining a color of the data associated with the source application for the executing of the second action.

11. A system comprising:
at least one programmable processor; and
a non-transitory machine-readable medium storing instructions that, when executed by the at least one programmable processor, cause the at least one programmable processor to perform operations comprising:
detecting, using at least one processor, a first action being executed on a data in a source computing application;
determining, using the at least one processor, a source color theme associated with at least one of the source computing application and the data;
determining, using the at least one processor, a destination color theme associated with a destination computing application, the destination computing application being communicatively coupled to the source application;
comparing, using the at least one processor, the source color theme and the destination color theme; and
executing, using the at least one processor, a second action on the data in the destination computing application based on the comparison of the source color theme and the destination color theme.

12. The system according to claim 11, wherein at least one of the source computing application and the destination computing application include at least one of the following: a software application, a user interface window of a software application, and any combination thereof.

13. The system according to claim 11, wherein the source computing application and the destination computing application are different computing applications.

14. The system according to claim 11, wherein the source computing application and the destination computing application are same computing applications.

15. The system according to claim 11, wherein the data includes at least one of the following: a video, an audio, an image, a graphics data, a text data, a rich text data, and any combination thereof.

16. The system according to claim 11, wherein the first action includes a copy action, and the second action includes a paste action.

17. The system according to claim 11, wherein the destination color theme is different from the source color theme.

18. The system according to claim 11, wherein the comparing includes changing a first color of the data associated with the source application into a second color for the executing of the second action.

19. The system according to claim 11, wherein the comparing includes adding highlighting to the data for the executing of the second action, and/or wherein the comparing includes retaining a color of the data associated with the source application for the executing of the second action.

20. A computer program product comprising a non-transitory machine-readable medium storing instructions that, when executed by at least one programmable processor, cause the at least one programmable processor to perform operations comprising:
detecting, using at least one processor, a first action being executed on a data in a source computing application;
determining, using the at least one processor, a source color theme associated with at least one of the source computing application and the data;
determining, using the at least one processor, a destination color theme associated with a destination computing application, the destination computing application being communicatively coupled to the source application;
comparing, using the at least one processor, the source color theme and the destination color theme; and
executing, using the at least one processor, a second action on the data in the destination computing application based on the comparison of the source color theme and the destination color theme.
